(19) United States
(12) Patent Application Publication
(10) Pub. No.: US 2016/0215123 A1
(43) Pub. Date: Jul. 28, 2016

(54) PHOSPHORUS-CONTAINING THERMOPLASTIC POLYESTER AND PHOSPHORUS-CONTAINING HEAT-SHRINKABLE TUBE MADE THEREFROM

(71) Applicant: NAN YA PLASTICS CORPORATION, Taipei (TW)

(72) Inventor: Zo-Chun JEN, Taipei (TW)

(21) Appl. No.: 14/603,425

(22) Filed: Jan. 23, 2015

(51) Int. Cl. C08K 5/5313; C08K 3/26

(52) U.S. Cl. CPC C08K 5/5313; C08K 3/26; C08K 2003/265

(57) ABSTRACT

A thermoplastic polyester is disclosed to contain a flame retardant and has an intrinsic viscosity between 0.70 and 1.10 dL/g, and for making the disclosed polyester a phosphorus-containing flame retardant is bound onto the molecular chains of the matrix polymer through modification of the molecular structure of the matrix polymer; wherein the disclosed polyester due to having a content of phosphorus between 3,000 and 30,000 ppm based on the weight of the polyester is suitable for making phosphorus-containing heat-shrinkable tubes that possess permanently flame-retardant properties, has a UL94 VTM-2 flame-retardant rating, and even meets the requirements for UL94 VTM-0 flame-retardant rating.

### BACKGROUND OF THE PRESENT INVENTION

1. Field of the Invention

The present invention relates to a co-polyester that contains phosphorus-based flame retardant, and more particularly to a heat-shrinkable tube made from such a co-polyester, being retardant to flame, and meeting the requirements for UL94 VTM-2 flammability rating, even meeting the requirements for UL94 VTM-0 flammability rating.

2. Description of Related Art

Heat-shrinkable tubes are extensively used for wrapping various conductive materials for protection and insulation. Some given technologies, such as U.S. Pat. Nos. 3,941,752; 4,157,436; 4,940,772; 5,665,801 and 5,859,173, as well as Japan Patent Nos. 3169104 and 3329410, have proposed certain polyesters containing flame retardants, and these existing materials have been widely used to make flame-retardant polyester fibers, textiles, films and circuit boards. But, none of flame-retardant heat-shrinkable tubes is/are applied in the market.

As PVC is banned, heat-shrinkable tubes for use in electrical insulation have no more been made with PVC. As substitutes, some relevant polyester disclosed in given prior arts are suitably used for making heat-shrinkable tubes, yet none of given prior arts has ever mentioned about using polyesters containing flame retardants to produce heat-shrinkable tubes having a flame-retardant property.

### SUMMARY OF THE INVENTION

In view of this, the main object of the present invention is to disclose a kind of thermoplastic polyester having an intrinsic viscosity of between 0.70 and 1.10 dL/g as well as having a flame-retardant effect, the disclosed polyester is obtained by making a phosphorus-containing flame retardant bound onto its own molecular chains of matrix polymer through a process of modification to modify its molecular structure.

The disclosed polyester has a content of phosphorus element between 3,000 and 30,000 ppm by weight of the polyester, and is suitable for making phosphorus-containing heat-shrinkable tubes that possess permanently flame-retardant properties. The resulting phosphorus-containing heat-shrinkable tube has a UL94 VTM-2 flame-retardant rating, and even meets the requirements for UL94 VTM-0 flame-retardant rating.

The disclosed polyester further comprises inorganic particles between 0.005 and 0.5 wt % based on the weight of the polyester, and the inorganic particles having a particle size between 0.1 and 0.5 μm are selected from titanium oxide, barium sulfate, calcium carbonate or silicon dioxide.

Another primary objective of the present invention is to provide a phosphorus-containing heat-shrinkable tube that is flame-retardant and heat-shrinkable. The heat-shrinkable tube is either purely made of the thermoplastic polyester incorporated with a flame retardant containing the element phosphorus, or made of a mixture of the thermoplastic polyester that has a phosphorus-containing flame retardant and a thermoplastic polyester not containing any flame retardants. The tube has a content of the element phosphorus between 3,000 and 12,000 ppm based on its weight. When used to wrapping an article, the tube provides the article it wraps with flame retardancy and insulation.

The phosphorus-containing heat-shrinkable tube being flame-retardant and heat-shrinkable has a machine-directional shrinkage between 5% and 15%, and a transverse-directional shrinkage greater than 35% when exposed to boiling water.

When having thermally shrunk and wrapped an article, the phosphorus-containing heat-shrinkable tube remains perfectly wraps the article without wrinkling, protuberating, slacking, coming-off, chapping and warping after exposed to a temperature of 180° C. for 30 minutes or exposed to a temperature of 105° C. for 180 minutes (or 3 hours).

The phosphorus-containing heat-shrinkable tube has a UL94 VTM-2 flame retardant rating, and even meets the requirements for UL94 VTM-0 flame retardant rating. The phosphorus-containing heat-shrinkable tube is thus suitable for wrapping various conductors and/or electronics, so as to provide the wrapped conductors and/or electronics with flame retardancy and insulation.

### DETAILED DESCRIPTION OF THE INVENTION

The thermoplastic polyester of the present invention made by binding a phosphorus-containing flame retardant onto the molecular chains of the matrix polymer is in nature a co-polyester polymer as a result of modification of the molecular structure of the matrix (hereinafter referred to as the phosphorus-containing thermoplastic polyester). The disclosed thermoplastic polyester is permanently flame-retardant, and is suitable for making flame-retardant heat-shrinkable tubes. When used to wrap electronics, the disclosed heat-shrinkable tube provides the wrapped article with flame retardancy and insulation.

The disclosed phosphorus-containing thermoplastic polyester is made of a dioic acid, a diol and a phosphorus-containing flame retardant element through a conventional process for synthesizing polyesters. For example, a PTA making process or a DMT making process may be used to synthesize the disclosed phosphorus-containing thermoplastic polyester. In this case, phosphorus-containing flame retardant is added anytime before the end of the esterification of the dioic acid and the diol, or is added directly into the plasma of the dioic acid and the diol.

The dioic acid is mainly pure terephthalic acid (PTA) or its ester thereof, and additional secondary components may be added, such as isophthalic acid; 2,6-naphthalenedicarboxylic acid; or their esters. However, these secondary components are not necessary and, if used, jointly form a part of less than 15 mol % in the co-polyester.

The diol is mainly ethylene glycol (EG), and additional secondary diols may be added, such as one selected from the group consisting of diethylene glycol; 1,4-cyclohexanedimethanol; propylene glycol; 2,2-dimethyl-1,3-propylene glycol (NPG); 2-ethyl-2-butyl-1,3-propylene glycol (BEPG) and butanediol. However, these secondary diols are not necessary and, if used, jointly form a part of less than 15 mol % in the co-polyester. Otherwise, the resultant phosphorus-containing thermoplastic polyester would become an amorphous state, and tend to have agglomeration during the solid-state polycondensation, making it difficult to increase the intrinsic viscosity of the phosphorus-containing thermoplastic polyester.

The phosphorus-containing flame retardant may be one or a combination of more phosphorus-containing compounds selected from those having the chemical structure formulas of (I), (II), (III), (IV), (V), (VI), (VII) and (VIII), and preferably is one having the chemical structure formulas (I), (II), (III) or (IV), or a combination thereof:

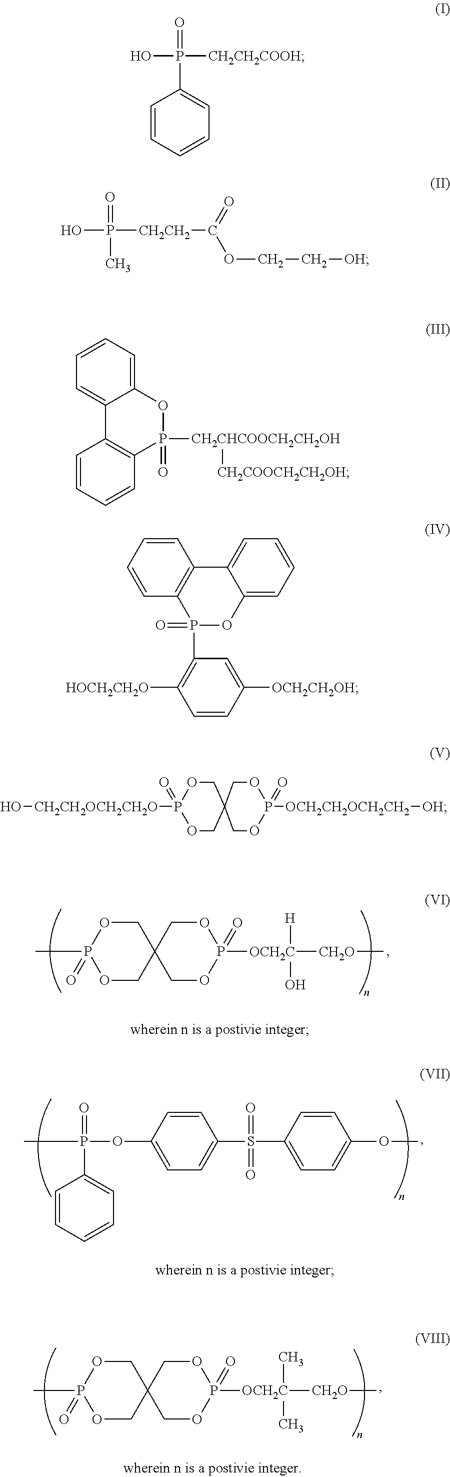

The disclosed phosphorus-containing thermoplastic polyester has a content of phosphorus between 3,000 and 30,000 ppm based on the weight of the polyester. When the phosphorus-containing thermoplastic polyester has a content of phosphorus lower than 3,000 ppm, the resultant heat-shrinkable tube fails to meet the requirements for UL94 VTM-2 flame retardant rating. On the other hand, when the content of phosphorus higher than 30,000 ppm, it is difficult for the polyester to have its intrinsic viscosity reaching the range between 0.70 and 1.10 dL/g, and the undesirably low intrinsic viscosity can make the polyester more unstable during the tube blowing process, and can lead to significant thickness variations of the produced heat-shrinkable tubes.

The disclosed phosphorus-containing thermoplastic polyester has its intrinsic viscosity between 0.70 and 1.10 dL/g, preferably between 0.80 and 1.00 dL/g, and most preferably between 0.80 and 0.90 dL/g. In the case of using either the PTA making process or the DMT making process to synthesize the polyester, it is possible to directly increase the intrinsic viscosity to the range between 0.70 and 1.10 dL/g during the melt polymerization process. Alternatively, it is possible to increase the intrinsic viscosity to the range between 0.70 and 1.10 dL/g during the solid-state polymerization process. When the phosphorus-containing thermoplastic polyester has an intrinsic viscosity lower than 0.70 dL/g, the heat-shrinkable tubes made by melting and extruding the polyester tend to have inconsistent thickness. On the other hand, if the intrinsic viscosity is higher than 1.10 dL/g, in the process of melting and extruding the polyester to produce heat-shrinkable tubes, material ejection tends to be hindered, adding difficulty to the extrusion of the heat-shrinkable tubes and the tube-blowing process.

The following description is directed to an example where a PTA making process is implemented to make the disclosed phosphorus-containing thermoplastic polyester. The process comprising steps of:
1. adding the phosphorus-containing flame retardant into a batch of plasma formulated with pure terephthalic acid (PTA) and ethylene glycol (EG), wherein the EG/PTA molar ratio is between 1.0 and 2.0;
2. continuously pumping the plasma into an esterification reactor for a first direct esterification, wherein ethylene glycol and water generated during the direct esterification are guided through a vaporizing tube into a distillation column for separation, and the ethylene glycol collected at the bottom of the distillation column is led back to the esterification reactor;

wherein, the material temperature for esterification is between 240 and 270° C., and preferably between 250 and 260° C., and the esterification pressure is between the normal atmosphere and 2.0 Kg/cm², and preferably between 0.01 and 1.0 Kg/cm², and the esterification time is between 3 and 8 hours, preferably between 4 and 6 hours, and the conversion rate of the monomer at the exit of the esterification reactor is at least 92%, and preferably higher than 95%.
3. performing a second polycondensation, wherein the monomer produced by the foregoing esterification is pumped to a prepolymerization tank for prepolymerization;

wherein, the material temperature for prepolymerization is between 260 and 280° C., and preferably between 250 and 260° C.; and the prepolymerization pressure is between 10 and 200 mmHg; and the prepolymerization time is between 0.5 and 2.0 hours; and the gaseous by-products of prepolymerization such as ethylene glycol are vacuum-pumped a cooler to be cooled into liquid;
4. continuously pumping the oligomer produced by the foregoing prepolymerization into a high-vacuum finisher for further polycondensation, so as to increase its intrinsic viscosity to 0.50 dl/g or more, more preferably 0.60 dl/g or more, and most preferably 0.70 dl/g or more;

wherein, the material temperature in the finisher is between 265 and 290° C., preferably lower than 285° C.; and the vacuum pressure in the finisher is lower than 2 mmHg; and
5. continuously pumping the polymer produced by the finisher to a diehead where it is extruded as rods, which are then fast cooled by chill water before being cut by a grain-cutting machine into grains of the disclosed phosphorus-containing thermoplastic polyester.

The following description is directed to an example where a DMT making process is implemented to make the disclosed phosphorus-containing thermoplastic polyester. The process comprising steps of:
1. taking a ester of a dioic acid as a material to perform ester exchange reaction with a diol, and adding an ester exchange catalyst before the reaction starts, such as manganous acetate, wherein methanol generated in the ester exchange reaction is separated by a distillation column and not introduced into the ester exchange tank;
2. adding the phosphorus-containing flame retardant anytime before the end of esterification; and
3. when the generated amount of methanol reaches 98% theoretical capacity, adding a catalyst selected from antimony catalyst, germanium catalyst, titanium catalyst and any combination thereof, for performing polymerization in a vacuum environment, and when the co-polyester reaches a viscosity higher than 0.7 dL/g, immediately taking the co-polyester out from the polymerization process, fast cooling it and cutting it into phosphorus-containing thermoplastic polyester (grains).

An alternatively way to make the disclosed phosphorus-containing thermoplastic polyester is to first perform melt blending on the phosphorus-containing flame retardant and a phosphorus-free thermoplastic polyester, and perform solid-state polymerization on the blend, so as to obtain a phosphorus-containing thermoplastic polyester having an intrinsic viscosity between 0.70 and 1.10 dL/g.

The disclosed phosphorus-containing thermoplastic polyester further comprises inorganic particles between 0.005 and 1.0 wt %, preferably between 0.005 and 0.5 wt %, most preferably between 0.01 and 0.5 wt %, based on the weight of the polyester. The inorganic particles shall be added in the reactor after the end of esterificaiton reaction but before the polymerization starts.

The inorganic particles are selected from titanium oxide, barium sulfate, calcium carbonate or silicon dioxide, with a particle size less than 1 μm, preferably between 0.1 and 0.5 μm.

The inorganic particles and the phosphorus-free thermoplastic polyester may jointly form a masterbatch, and then the masterbatch receives the melt blending process together with the phosphorus-containing flame retardant to form the disclosed phosphorus-containing thermoplastic polyester.

The heat-shrinkable tube of the present invention is made of the disclosed phosphorus-containing thermoplastic polyester. Based on the weight of the heat-shrinkable tube weight, it has a content of phosphorus between 3,000 and 12,000 ppm, and is a flame-retardant heat-shrinkable tube (hereinafter referred to as the phosphorus-containing heat-shrinkable tube).

The disclosed phosphorus-containing heat-shrinkable tube has a thickness between 20 and 200 μm and a circumference between 4 and 300 mm as well as has a UL94 VTM-2 flame-retardant rating, and even meets the requirements for UL94 VTM-0 flame-retardant rating.

The disclosed phosphorus-containing heat-shrinkable tube if made from the phosphorus-containing thermoplastic polyester incorporating the inorganic particles, when burned, can prevent melt-dropping and has flame-retardant capacity meeting the requirements for UL94 VTM-0 flame retardant rating.

The disclosed phosphorus-containing heat-shrinkable tube is made through the following steps:
1. taking only the disclosed phosphorus-containing thermoplastic polyester or a mixture of the disclosed phosphorus-containing thermoplastic polyester and a phosphorus-free thermoplastic polyester in a weight ratio of 10˜40:60˜90 (hereinafter collectively referred to as the phosphorus-containing thermoplastic polyester) as the starting material, and drying the phosphorus-containing thermoplastic polyester in dehumidified air of 150˜170° C. for 4˜6 hours;
2. melting the phosphorus-containing thermoplastic polyester into gel under a temperature between 250 and 270° C., and using an extruder with a ring-like die to extrude the phosphorus-containing thermoplastic polyester gel into un-stretched hollow tube preforms;
3. immediately passing the preforms through a cooling bath for cooling, and passing the preforms between a set of feeding rollers with a rotational speed set as 100 rpm, so as to bring the preforms into a hot-water bath or an Infrared lamp heating device where the preforms are heated to a temperature higher than their glass transition temperature, then introducing compressed air to such blow the preforms that the preforms have their diameter expanding to 1.3 time or more, wherein the temperature for the tube-blowing process is preferably between 85° C. and 105° C.; and
4. taking up the expended tube with a set of nip rollers with a rotational speed set as 105 rpm, so as to obtain the disclosed phosphorus-containing heat-shrinkable tube.

The un-stretched hollow tube preform for the disclosed phosphorus-containing heat-shrinkable tube is expended in the transverse direction (TD) during the tube-blowing process, and is expended twice in the machine direction (MD) when passing through the feeding and nip rollers. As a result, the disclosed phosphorus-containing heat-shrinkable tube has a machine-direction (MD) draw ratio equal to a ratio between the drawing speed for the expended tube and the feeding speed for the perform, and has a transverse direction (TD) draw ratio equal to a ratio between the diameter of the expended tube and the diameter of the preform.

The disclosed phosphorus-containing heat-shrinkable tube preferably has its machine direction (MD) draw ratio between 1.0 and 3.0, and its transverse direction (TD) draw ratio between 1.3 and 4.5.

The disclosed phosphorus-containing heat-shrinkable tube is cooled immediately after the MD and TD elongation, and is heat-shrinkable. In other words, upon application of heat, the heat-shrinkable tube performs shrinkage in both the transverse direction (TD) and the machine direction (MD). Thus, when the disclosed phosphorus-containing heat-shrinkable tube is mounted around an article and then heated, it performs TD shrinkage and MD shrinkage to wrap the article fittingly.

The disclosed phosphorus-containing heat-shrinkable tube further has the following characteristics:
1. After put into 100° C.-boiling water for 30 seconds, the phosphorus-containing heat-shrinkable tube displays an MD thermal shrinkage between 5% and 15% and a TD thermal shrinkage higher than 35%.

If the MD thermal shrinkage rate is lower than 5%, the phosphorus-containing heat-shrinkable tube is unable to fittingly wrap the article. If the MD thermal shrinkage rate is higher than 15%, the phosphorus-containing heat-shrinkable tube can deform and displace when wrapping the article. If the TD thermal shrinkage is lower than 35%, the wrapping closeness of the heat-shrinkable tube may be insufficient.
2. When having thermally shrunk and wrapped an article, the phosphorus-containing heat-shrinkable tube remains perfectly wraps the article without defects wrinkling, protuberating, slacking, coming-off, chapping and warping after exposed to a temperature of 180° C. for 30 minutes or exposed to a temperature of 105° C. for 180 minutes.
3. The phosphorus-containing heat-shrinkable tube is applicable to wrap aluminum capacitors, lithium cells and motor coils, so as to endow the wrapped aluminum capacitors, lithium cells and motor coils with flame retardancy and insulation.
4. The phosphorus-containing heat-shrinkable tube, when including inorganic particles, can relax better after rolled up.
5. The phosphorus-containing heat-shrinkable tube printed with patterns remains the patterns clear and sharp even after cleaned by acetone.

An alternative way to make the disclosed phosphorus-containing heat-shrinkable tube is achieved using a double bubble tubular film extrusion process.

Some embodiments and comparative examples are given below to further demonstrate the physical properties and characteristics of the disclosed heat-shrinkable tube.
1. Test for flame-retardant rating:

To perform according to UL94-VTM Thin Material Vertical Burning Test.
2. Test for stability during tube blowing:

To observe the heat-shrinkable tube has a consistent thickness or not.
3. Test for wrapping appearance:

To observe whether the phosphorus-containing heat-shrinkable tube, having thermally shrunk and wrapped an article, remains perfectly fit the surface of the article without wrinkling, protuberating, slacking, coming-off, chapping and warping after placed in an oven to be exposed to a temperature of 180° C. for 30 minutes or exposed to a temperature of 105° C. for 180 minutes.

### [Preformed “Phosphorus-Free Polyester Grains”]

### 1. Sample PET-A Polyester Grain:

To use a kind of co-polyester contains about 2.5 mole % IPA.

### 2. Sample PET-C Polyester Grain:

To use a kind of co-polyester contains about 10 mole % IPA.

### [Preformed “Phosphorus-Containing Polyester Grains”]

### 1. PET-F1 Polyester Grain by Using Flame Retardant (I)

Measure bis-hydroxyethyl terephtalate monomer (hereinafter abbreviated as BHET) of 10.81 parts by weight, Flame Retardant (I) (i.e., propionic acid 3-(hydroxyphenylphosphinyl)) of 0.4478 parts by weight and ethylene glycol (EG) of 3.243 parts by weight, then put these materials into a reactor for melt polymerization process reaction.

According to the foregoing process for making the disclosed phosphorus-containing thermoplastic polyester, a batch of phosphorus-containing polyester grains having a content of phosphorus of 6,000 ppm and an intrinsic viscosity for melt polycondensation of 0.65 dL/g was synthesized. After solid-state polymerization, the obtained PET-F1 polyester grain has its intrinsic viscosity of 0.80 dL/g.

### 2. PET-F2 Polyester Grain by Using Flame Retardant (II)

Measure BHET of 10.81 parts by weight, Flame Retardant (II) (i.e., oxaphospholane glycol ester) of 0.522 parts by weight and ethylene glycol (EG) of 3.243 parts by weight, then put these materials into a reactor for melt polymerization process reaction.

According to the foregoing process for making the disclosed phosphorus-containing thermoplastic polyester, a batch of phosphorus-containing polyester grains having a content of phosphorus of 6,000 ppm and an intrinsic viscosity for melt polycondensation of 0.65 dL/g was synthesized. After solid-state polymerization, the obtained PET-F2 polyester grain has its intrinsic viscosity of 1.10 dL/g.

### 3. PET-F3 Polyester Grain by Using Flame Retardant (III)

Measure BHET of 10.81 parts by weight, Flame Retardant (III) (i.e., butanedioicacid, bis(2-hydroxyethyl)(6H-dibenz[c,e][1,2]oxaphosphorin-6-ylmethyl) ester) of 0.84 parts by weight and ethylene glycol (EG) of 3.243 parts by weight, then put these materials into a reactor for melt polymerization process reaction.

According to the foregoing process for making the disclosed phosphorus-containing thermoplastic polyester, a batch of phosphorus-containing polyester grains having a content of phosphorus of 6,000 ppm and an intrinsic viscosity for melt polycondensation of 0.65 dL/g was synthesized. After solid-state polymerization, PET-F3 polyester grain has its intrinsic viscosity of 0.9 dL/g.

### 4. PET-F4 Polyester Grain by Using Flame Retardant (IV)

Measure BHET of 10.81 parts by weight, Flame Retardant (IV) (i.e., 2-(9,10-dihydro-9-oxa-10-phosphaphenanthrene-10-oxide)-1,4-bis(2-hydroxyethoxy)phenylene ester) of 0.8695 parts by weight and ethylene glycol (EG) of 3.243 parts by weight, then put these materials into a reactor for melt polymerization process reaction.

According to the foregoing process for making the disclosed phosphorus-containing thermoplastic polyester, a batch of phosphorus-containing polyester grains having a content of phosphorus of 6,000 ppm and an intrinsic viscosity for melt polycondensation of 0.65 dL/g was synthesized. After solid-state polymerization, PET-F4 polyester grain has its intrinsic viscosity of 0.9 dL/g.

### 5. PET-F5 Polyester Grain by Using Flame Retardant (I)

The obtained PET-F5 polyester grain is, in addition to having a phosphorus content of 30,000 ppm and an intrinsic viscosity for melt polycondensation of 0.60 dL/g, made by the same synthesizing process as making PET-F1 polyester. After solid-state polymerization, PET-F5 polyester grain has its intrinsic viscosity of 0.80 dL/g.

### 6. PET-F6 Polyester Grain by Using Flame Retardant (I)

The obtained PET-F6 polyester grain is, in addition to having a phosphorus content of 6,000 ppm, a calcium carbonate content of 3,000 ppm and an intrinsic viscosity for melt polycondensation of 0.65 dL/g, made by the same synthesizing process as making PET-F1 polyester. After solid-state polymerization, PET-F6 polyester grain has its intrinsic viscosity of 0.8 dL/g.

### 7. PET-F7 Polyester Grain by Using Flame Retardant (I)

Made by using a twin-screw extruder to melt and blend PET-A polyester grain and Flame Retardant (I), then using the process for making the disclosed phosphorus-containing thermoplastic polyester to synthesize phosphorus-containing polyester grains containing 6,000 ppm phosphorus. After solid-state polymerization, PET-F7 polyester grain has its intrinsic viscosity of 0.8 dL/g.

### Embodiment 1

Heat-shrinkable tubes were made of PET-F1 polyester grains. Formulas of polyester grain and the test results are listed in Table 1.

### Embodiment 2

Heat-shrinkable tubes were made of PET-F2 polyester grains. Formulas of polyester grain and the test results are listed in Table 1.

### Embodiment 3

Heat-shrinkable tubes were made of PET-F3 polyester grains. Formulas of polyester grain and the test results are listed in Table 1.

### Embodiment 4

Heat-shrinkable tubes were made of PET-F4 polyester grains. Formulas of polyester grain and the test results are listed in Table 1.

### Embodiment 5

A heat-shrinkable tube was made of PET-A polyester grain and PET-F5 polyester grain premixed in a weight ratio of 60:40. Formulas of polyester grain and the test results are listed in Table 1.

### Embodiment 6

A heat-shrinkable tube was made of PET-A polyester grain and PET-F5 polyester grain premixed in a weight ratio of 80:20. Formulas of polyester grain and the test results are listed in Table 1.

### Embodiment 7

A heat-shrinkable tube was made of PET-A polyester grain and PET-F5 polyester grain premixed in a weight ratio of 90:10. Formulas of polyester grain and the test results are listed in Table 1.

### Embodiment 8

Heat-shrinkable tubes were made of PET-F6 polyester grain. Formulas of polyester grain and the test results are listed in Table 1.

### Embodiment 9

Heat-shrinkable tubes were made of PET-F7 polyester grain. Formulas of polyester grain and the test results are listed in Table 1.

### Comparative Example 1

A heat-shrinkable tube was made of PET-C polyester grain. Formulas of polyester grain and the test results are listed in Table 1.

### Comparative Example 2

A heat-shrinkable tube was made of PET-C polyester grain and PET-F5 polyester grain premixed in a weight ratio of 92:8. Formulas of polyester grain and the test results are listed in Table 1.

### Comparative Example 3

A heat-shrinkable tube was made of PET-F1 polyester grain before solid-state polymerization (IV=0.65 dL/g). Formulas of polyester grain and the test results are listed in Table 1.

TABLE 1
Weight-Based Formulas of Polyester Grain and Measurements of
Heat-Shrinkable Tubes Made Therefrom

| | | Example | | | | | | | | | | | |
|---|---|---|---|---|---|---|---|---|---|---|---|---|---|
| | | | | | | | | | | | Comparative | | |
| | | Embodiment | | | | | | | | | Example | | |
| | | 1 | 2 | 3 | 4 | 5 | 6 | 7 | 8 | 9 | 1 | 2 | 3 |
| PET-A¹ | | — | — | — | — | 60 | 80 | 90 | — | — | — | — | — |
| (Parts by weight) | | | | | | | | | | | | | |
| PET-C² | | — | — | — | — | — | — | — | — | — | 100 | 92 | — |
| (Parts by weight) | | | | | | | | | | | | | |
| PET-F1³ | | 100 | — | — | — | — | — | — | — | — | — | — | 100 |
| (Parts by weight) | | | | | | | | | | | | | |
| PET-F2⁴ | | — | 100 | — | — | — | — | — | — | — | — | — | — |
| (Parts by weight) | | | | | | | | | | | | | |
| PET-F3⁵ | | — | — | 100 | — | — | — | — | — | — | — | — | — |
| (Parts by weight) | | | | | | | | | | | | | |
| PET-F4⁶ | | — | — | — | 100 | — | — | — | — | — | — | — | — |
| (Parts by weight) | | | | | | | | | | | | | |
| PET-F5⁷ | | — | — | — | — | 40 | 20 | 10 | — | — | — | 8 | — |
| (Parts by weight) | | | | | | | | | | | | | |
| PET-F6⁸ | | — | — | — | — | — | — | — | 100 | — | — | — | — |
| (Parts by weight) | | | | | | | | | | | | | |
| PET-F7⁹ | | — | — | — | — | — | — | — | — | 100 | — | — | — |
| (Parts by weight) | | | | | | | | | | | | | |
| Phosphorus | | 6,000 | 6,000 | 6,000 | 6,000 | 12,000 | 6,000 | 3,000 ppm | 6,000 | 6,000 ppm | — | 2,400 ppm | 6,000 ppm |
| Content | | ppm | ppm | ppm | ppm | ppm | ppm | | ppm | | | | |
| Tube-Making | | Stable | Stable | Stable | Stable | Stable | Stable | Stable | Stable | Stable | Stable | Stable | Unstable |
| Stability | | | | | | | | | | | | | |
| Flame Retardant | | UL94 | UL94 | UL94 | UL94 | UL94 | UL94 | UL94 | UL94 | UL94 | Burned | UL94 | — |
| Rating | | VTM-0 | VTM-0 | VTM-0 | VTM-0 | VTM-0 | VTM-0 | VTM-2 | VTM-0 | VTM-0 | Out | HB | |
| Test for | 180° C. × | Pass | Pass | Pass | Pass | Pass | Pass | Pass | Pass | Pass | Pass | Pass | |
| wrapping | 30 min | | | | | | | | | | | | |
| appearance | 105° C. × | Pass | Pass | Pass | Pass | Pass | Pass | Pass | Pass | Pass | Pass | Pass | |
| | 3 hr | | | | | | | | | | | | |

Note:
¹PET-A contains IPA 2.5 mole %; IV = 0.72 dl/g;
²PET-C contains IPA 10 mole %; IV = 0.85 dl/g;
³PET-F1 uses Flame Retardant (I) and contains phosphorus content of 6,000 ppm; IV = 0.80 dl/g;
⁴PET-F2 uses Flame Retardant (II) and contains phosphorus content of 6,000 ppm; IV = 1.10 dl/g;
⁵PET-F3 uses Flame Retardant (III) and contains phosphorus content of 6,000 ppm; IV = 0.90 dl/g;
⁶PET-F4 uses Flame Retardant (IV) and contains phosphorus content of 6,000 ppm; IV 0.90 dl/g;
⁷PET-F5 uses Flame Retardant (I) and contains phosphorus content of 30,000 ppm; IV = 0.80 dl/g;
⁸PET-F6 uses Flame Retardant (I) and contains phosphorus content of 6,000 ppm and calcium carbonate content of 3,000 ppm; IV = 0.80 dl/g;
⁹PET-F7 is made by using a twin-screw extruder and use uses Flame Retardant (II) and contains phosphorus content of 6,000 ppm; IV = 0.80 dl/g.

### RESULTS

According to Table 1, the phosphorus-containing heat-shrinkable tubes made of the polyesters of Embodiments 1 through 9 are found to be flame retardant and heat-shrinkable, with the flame retardant ability meeting at least the requirements for UL94 VTM-0 flame retardant rating. Also, the resultant phosphorus-containing heat-shrinkable tubes all showed wrapping integrity after 180° C.-heating for 30 minutes and after 105° C.-heating for 3 hours, thus satisfying the industrial standards.

What is claimed is:

1. A phosphorus-containing thermoplastic polyester for use in making phosphorus-containing heat-shrinkable tubes having a UL94 VTM-2 flame-retardant rating, characterized in that the polyester is, having an intrinsic viscosity between 0.70 and 1.10 dL/g and containing a content of phosphorus between 3000 and 30,000 ppm based on a weight of the polyester, obtained by having pure terephthalic acid (PTA) or ester thereof react with ethylene glycol (EG) at a molar ratio (EG/PTA) of EG to PTA ranging between 1.0 and 2.0 to undergo a direct esterification process and a polycondensation process successively in the presence of a phosphorus-containing flame retardant added before the end of esterification; wherein the phosphorus-containing flame retardant is one or a combination of phosphorus-containing compounds selected from those having the chemical structure formulas of (I), (II), (III), (IV), (V), (VI), (VII) or (VIII) as followed:

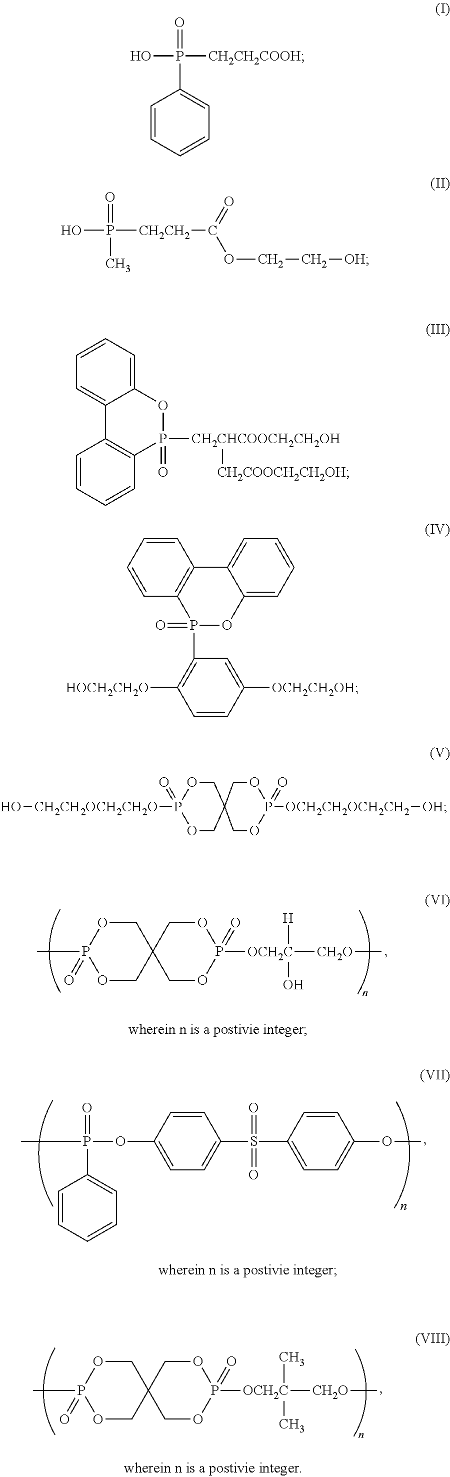

2. The polyester of claim 1, wherein the polyester further comprises inorganic particles between 0.005 and 0.5 wt % based on the weight of the polyester, and the inorganic particles having a particle size between 0.1 and 0.5 μm are selected from titanium oxide, barium sulfate, calcium carbonate or silicon dioxide.

3. The polyester of claim 1, wherein the intrinsic viscosity of the polyester is between 0.80 and 1.00 dL/g.

4. A phosphorus-containing heat-shrinkable tube made of the phosphorus-containing thermoplastic polyester of claim 1, comprising a content of phosphorus between 3,000 and 12,000 ppm based on a weight of the heat-shrinkable tube, and if exposed to boiling water having a machine-directional shrinkage between 5% and 15%, and a transverse-directional shrinkage greater than 35% as well as having a UL94 VTM-2 flame-retardant rating.

5. The phosphorus-containing heat-shrinkable tube of claim 4, wherein the phosphorus-containing heat-shrinkable tube, after having thermally shrunk and wrapped an article and then heated to a temperature of 180° C. for 30 minutes or 105° C. for 3 hours, has properties of still maintaining a perfect covering condition without defects of wrinkling, protuberating, slacking, coming-off, chapping and warping.

6. A phosphorus-containing heat-shrinkable tube made of the phosphorus-containing thermoplastic polyester of claim 2, based on a weight of the heat-shrinkable tube, containing a content of phosphorus between 3,000 and 12,000 ppm and inorganic particles between 0.01 and 0.5 wt %, and if exposed to boiling water having a machine-directional shrinkage between 5% and 15%, and a transverse-directional shrinkage greater than 35% as well as having a UL94 VTM-0 flame-retardant rating.

7. The phosphorus-containing heat-shrinkable tube of claim 6, wherein the phosphorus-containing heat-shrinkable tube, after having thermally shrunk and wrapped an article and then heated to a temperature of 180° C. for 30 minutes or 105° C. for 3 hours, has properties of still maintaining a perfect covering condition without defects of wrinkling, protuberating, slacking, coming-off, chapping and warping.
